(19) United States
(12) Patent Application Publication
(10) Pub. No.: US 2005/0050082 A1
(43) Pub. Date: Mar. 3, 2005

(54) [METHOD FOR ACCESSING REMOTE DATABASE USING A WINDOW PROGRAM]

(76) Inventor: YEUNG-CHUNG KUO, KAOHSIUNG CITY (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,032

(22) Filed: Sep. 3, 2003

(51) Int. Cl. G06F 7/00

(52) U.S. Cl. 707/102

(57) ABSTRACT

The present invention discloses a method for accessing remote database using a window program, and more particularly, relates to a method for accessing remote database using a window program that is created after windowizing the SQL syntax. The method for accessing remote database using a window program comprises the steps that are described as follows. Firstly, the user selects a remote database name to be connected via a connect-to-database function in the command list. Secondly, the window program determines whether the user authenticated for entering the remote database or not. If the user is authenticated, the user is allowed to select the SQL command from the SQL instruction area, and thus the selected SQL instruction is then displayed in the display area for further modification. Ultimately, the user utilizes an execute function in the command list to execute the modified SQL instruction and the resulting execution is displayed in the display area by the window program.

### BACKGROUND OF INVENTION

1. Field of the Invention

The present invention relates to a method for accessing data in a remote database using a window program, and more particularly, relates to a method for accessing remote database using a window program based on windowizing SQL syntax.

2. Description of Related Art

A prompt that is similar to a DOS prompt is provided by SQL Plus utility of the Oracle database, such that system personnel is able to input a series of commands as follows: SELECT dep_id FROM emp_tab WHERE sex=“M” GROUP BY dep_id.

Wherein, all uppercase letters, such as SELECT, FROM, WHERE and GROUP BY are reserved keywords for SQL Plus, and all lowercase letters refer to data table entries thereof to be queried.

However, the foregoing example is a rather simple query command complying with SQL Plus syntax, yet the input instruction becomes longer and more complicated as more query conditions are requested by system personnel.

Therefore, besides complication of instructions of SQL Plus utility, the instruction is limited to one at a time for the system personnel. As a result, even as simple as merely querying data tables from Oracle database has become a rather difficult task. If not expertise in SQL Plus instructions, a beginner normally has to refer to manuals and publications in the field for sufficient knowledge to give instructions.

### SUMMARY OF INVENTION

In the light of the above problems, it is a primary object of the present invention to provide a method for accessing remote database using a window program. The method facilitates the beginners in prompt querying, modifying, editing, testing, and deleting data in Oracle database, as well as provides a facility for switching between different Oracle database, so as to prepare for establishing a global Oracle database.

The remote Oracle database comprises a plurality of data tables, in which each data table comprises a plurality of fields, and each field comprises a plurality of entries. A window that is provided by the window program comprises a command list, a display area, and a SQL instruction area.

The method for accessing remote database via a window program comprises the steps that are described as follows. Firstly, a window is provided to the user, and the user selects a remote database to be connected via the connect-to-database function in the command list.

The window program then authenticates the user in order to determine whether the user is permitted to access the remote Oracle database or not. If the user is authenticated, the user is permitted to access the SQL instruction in the SQL instruction area. As the SQL instruction is selected, it is shown in the display area for further modification. In addition, the SQL instruction in the SQL instruction area comprises a query type SQL instruction and an edit type SQL instruction, which serve the user to query or modify data in remote Oracle database.

Thereafter, the user executes the modified SQL instruction with an execution function in the command list, and the window program displays an execution result in the display area.

Besides the connect-to-database and execute functions, the window program of the present invention further provides functions of export, load, save, clear, delete field, insert logic operator, cross reference data table, and data and field searching.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 illustrates a window according to one preferred embodiment of the present invention.

FIG. 2 illustrates a schematic flowchart according to one preferred embodiment of the present invention.

FIG. 3 illustrates a schematic view of a window of the connect-to-database function according to one preferred embodiment of the present invention.

FIG. 4 illustrates a schematic flowchart of the connect-to-database function according to one preferred embodiment of the present invention.

FIG. 5 illustrates a schematic flowchart of the query type SQL instruction function according to one preferred embodiment of the present invention.

FIG. 6 illustrates a schematic flowchart of the edit type SQL instruction function according to one preferred embodiment of the present invention.

FIG. 7 illustrates a schematic flowchart of the export function according to one preferred embodiment of the present invention.

FIG. 8 illustrates a schematic flowchart of the load function according to one preferred embodiment of the present invention.

FIG. 9 illustrates a schematic flowchart of the save function according to one preferred embodiment of the present invention.

FIG. 10 illustrates a schematic flowchart of the field delete function according to one preferred embodiment of the present invention.

FIG. 11 illustrates a schematic view of a window of the logic operator inserting function according to one preferred embodiment of the present invention.

FIG. 12 illustrates a schematic flowchart of the logic operator inserting function according to one preferred embodiment of the present invention.

FIG. 13A illustrates a schematic view of a window of the data table cross reference function according to one preferred embodiment of the present invention.

FIG. 13B illustrates a schematic view of a window of the data table cross reference function according to one preferred embodiment of the present invention.

FIG. 14 illustrates a schematic flowchart of the data table cross reference function according to one preferred embodiment of the present invention.

FIG. 15 illustrates a schematic view of a window of the data search function according to one preferred embodiment of the present invention.

FIG. 16 illustrates a schematic flowchart of the data search function according to one preferred embodiment of the present invention.

### DETAILED DESCRIPTION

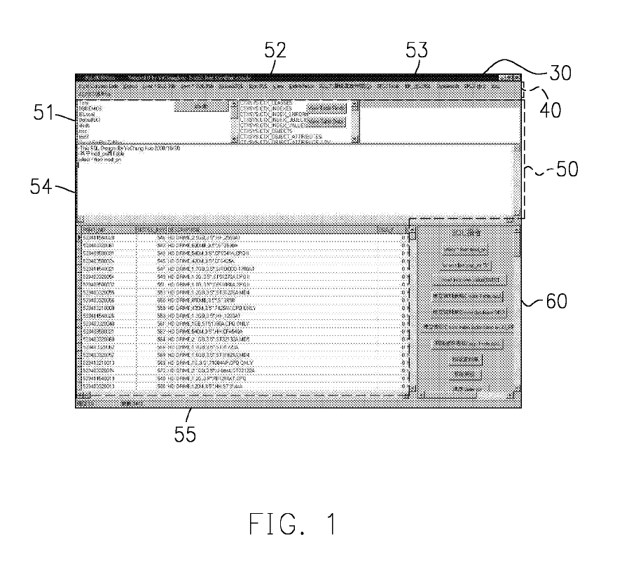

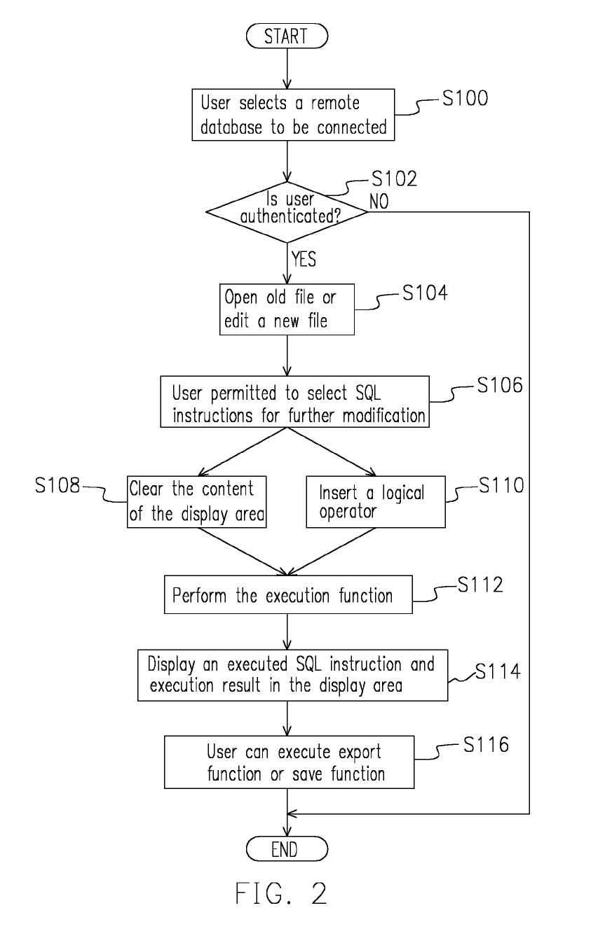

Referring to FIG. 1 through FIG. 4, which schematically show a method for accessing remote database using a window program according to a preferred embodiment of the present invention. The method windowizes the SQL syntax and thereby accesses remote database.

The remote Oracle database comprises a plurality of data tables, where each data table comprises a plurality of fields, and each field comprises a plurality of entries.

The window 30 provided by the window program comprises a command list 40, a display area 50, and a SQL instruction area 60. The display area 50 further comprises a database name display area 51, a data table display area 52, a data structure display area 53, an instruction area 54, and a data display area 55.

The method for accessing remote database using a window program comprises the steps that are described as follows. Firstly, the user takes the connect-to-database function (i.e. Input Connect Data of FIG. 1) in the command list 40 to select the remote database to be connected in step S100.

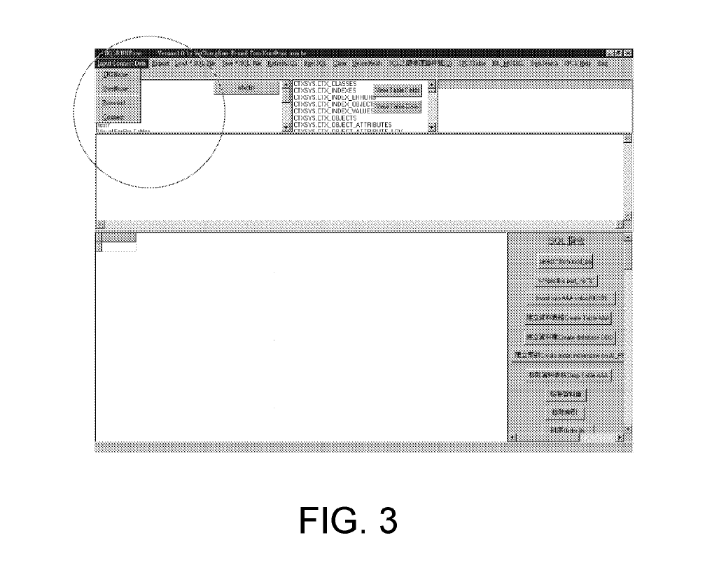

Notice there is a plurality of sub-functions pertaining to this function. In the pull-down menu of Input Connect Data, the user manages to enter a remote database name in the TNSName item, a user name in the UserName item, and a user password in the Password item. Lastly, the user manages to execute the Connect function to connect to the remote database, whereas all of the foregoing functions are shown in the command list 40 circled in FIG. 3.

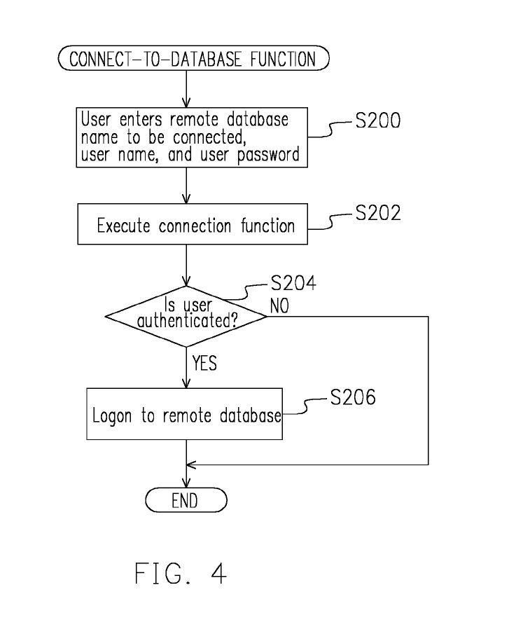

FIG. 4 is a schematic flowchart illustrating the connect-to-database function according to the present invention. The connect-to-database function comprises the steps that are described as follows. Firstly, the user enters a remote database name, a user name, and a user password in step S200. Next, the Connect function is executed in step S202 so that to authorize the user for logon the remote database or not in step s204, wherein user authentication means whether the provided user name and password are correct and corresponding. If they are both correct, the user then manages to logon to the remote database in step S206.

On the other hand, if the database name is unknown to the user, the desirable database name may be found in the database name display area 51.

Then, as the user authenticated for logon to the remote database in step S102, the user is permitted to select the SQL instruction from the SQL instruction area 60 in step S106. Wherein, after the SQL instruction is selected by the user, the selected SQL instruction is then displayed in the instruction display area 54 for further modification, for example, for entering data table name for query or deletion.

Besides comprising the query type SQL instruction and the edit type SQL instruction, the instruction in the SQL instruction area 60 further comprises a variety of instructions. In addition to the basic SQL instructions, the present invention further comprises 82 sets of SQL example in the SQL instruction area 60.

Therefore, after the user is authenticated in step S102, the user may use a load function (Load*SQL File) in the command list 40 to open an old instruction file which has been edited previously for further modification. Optionally, a new instruction file may be directly edited in the instruction display area 54.

After the user completes editing instruction, the execution function in the command list 40 executes the modified SQL instruction in step S112, and the execution result is then displayed in the data display area 55.

If the SQL instruction modified in step S106 is not satisfying, a clear function (i.e. Clear function in FIG. 1) in the command list 40 then serves to clear the content of the instruction display area 54 in step S108. On the other hand, if a logic operator is to be inserted in the modifying SQL instruction in step S106, a logic operator inserting function (i.e. SQL logic operator function in FIG. 1) in the command list 40 takes place as macro is expanded in step S110.

If the user shall save the SQL instruction that is modified in step S114, or shall export an execution result that is displayed, a save function (i.e. Save*SQL File of FIG. 1) in the command list 40 then serves to save the modified SQL instruction in a file in step S116. On the other hand, an export function (i.e. Export of FIG. 1) in the command list 40 then serves to display and save the execution results in different file formats.

The features of the sub display area in the display area 50 are described hereinafter. The display area 50 comprises a plurality of sub display areas including a database name display area 51, which is roughly described above, mainly for displaying the remote database name to be connected. A data table display area 52 for displaying all data tables existing in the remote database. A data structure display area 53 for displaying the data structure existing in the data table, for example, if a field A in the data table is subject to integer format, the field name and the data structure thereof are displayed accordingly in the data structure display area 53. An instruction display area 54 for displaying the SQL instruction created by expanding the macro. And a data display area 55 for displaying the data contained in each field.

As described in step S100, the reason for inserting a logic operator in a open macro SQL instruction is that there is a plurality SQL instructions in SQL instruction area being subject to macro format therein. Besides, each SQL instruction corresponds to a macro button for the user's execution.

In addition, the user manages to logon to a plurality of remote database and to access the data therein with connect-to-database function provided by the window program in the present invention.

Referring to FIG. 1 and FIGS. 5 to 16, a method for accessing remote database using a window program is schematically shown according to another preferred embodiment in the present invention. The method windowizes SQL syntax so as to facilitate the user to access remote database with SQL syntax.

According to one preferred embodiment in the present invention, the user is authorized to logon to remote database in order to operate a series of functions for accessing the data therein.

The series of functions is shown in the command list 40, which comprises an execution function including a query type and an edit type instruction (i.e. RefreshSQL function and ExecSQL function in FIG. 1), an export function (i.e. Export function in FIG. 1), a load function (i.e. Load*SQL File function in FIG. 1), a save function (i.e. Save*SQL File function in FIG. 1), a clear function (i.e. Clear function in FIG. 1), a field delete function (i.e. Field delete function in FIG. 1), a logic operator inserting function (i.e. SQL logic operator function in FIG. 1), a data table cross reference function (i.e. ER_MODEL function of FIG. 1), and a data and field searching function (i.e. Data Search function in FIG. 1).

Where the clear function is for clearing the content in the instruction display area 54.

Next, the execution flow of the foregoing functions in the command list 40 is described hereinafter.

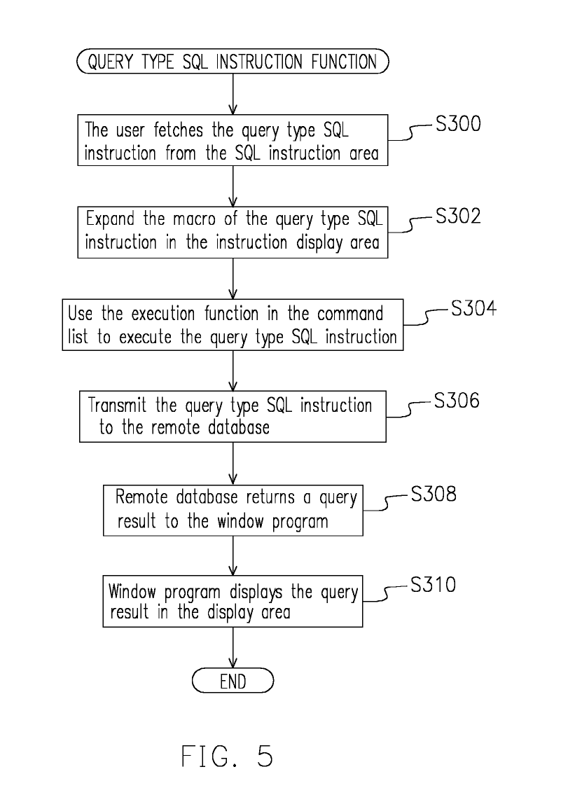

Referring to FIG. 5, it illustrates a schematic flowchart of the query type SQL instruction according to one preferred embodiment of the present invention. Firstly, the user fetches a query type SQL instruction in the SQL instruction area 60 in step S300. In other words, the user presses the execution button for query type SQL instruction, so as to expand macro in the instruction display area 54 in step S302. Next, a RefreshSQL function from the instruction list 40 executes SQL query type instruction in step S304.

The execution function transmits the query type SQL instruction to the remote database in step S306. The remote database then returns a query result to the window program in step S308 so as to display the query result in the data display area 55 in step S310.

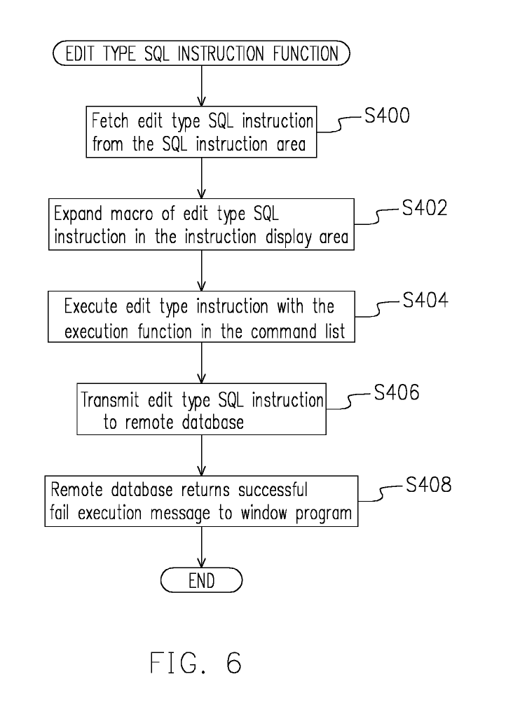

Referring to FIG. 6, it illustrates a schematic flowchart of the edit type SQL instruction according to one preferred embodiment of the present invention. Firstly, the user fetches an edit type SQL instruction in the SQL instruction area 60 in step S400. The macro in the edit type SQL instruction is expanded in the instruction display area 54 in step S402. Then, ExecSQL function in the command list 40 executes the edit type SQL instruction in step S404.

The window program then transmits the edit type SQL instruction to the remote database in step S406. The remote database then returns a message indicating a successful execution or a fail execution to the window program in step S408.

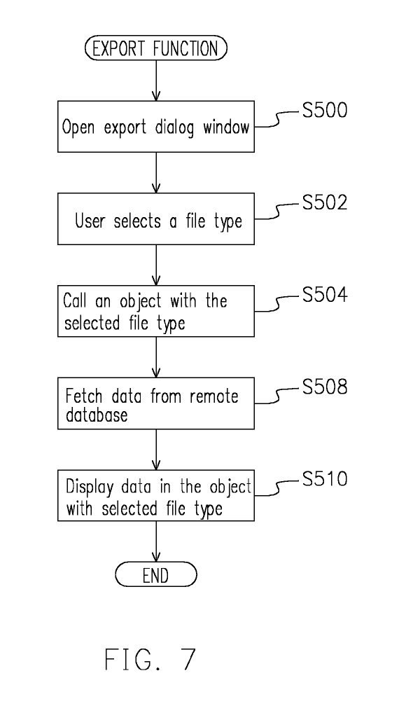

FIG. 7 illustrates a schematic flowchart of the export function according to one preferred embodiment of the present invention. The export function comprises the steps that are described as follows. Firstly, opening an export dialog window in step S500, wherein the export dialog window comprises a plurality of file formats including Excel, ASCII, Dbase, Pardox, CSV, etc.

Secondly, as the user calls for one of the file formats in step S502, the window program calls for one object with the selected file format in step S504. Further, the data in the remote database is fetched in step S508. Ultimately, the data content is displayed in the object with the selected file format in step S510.

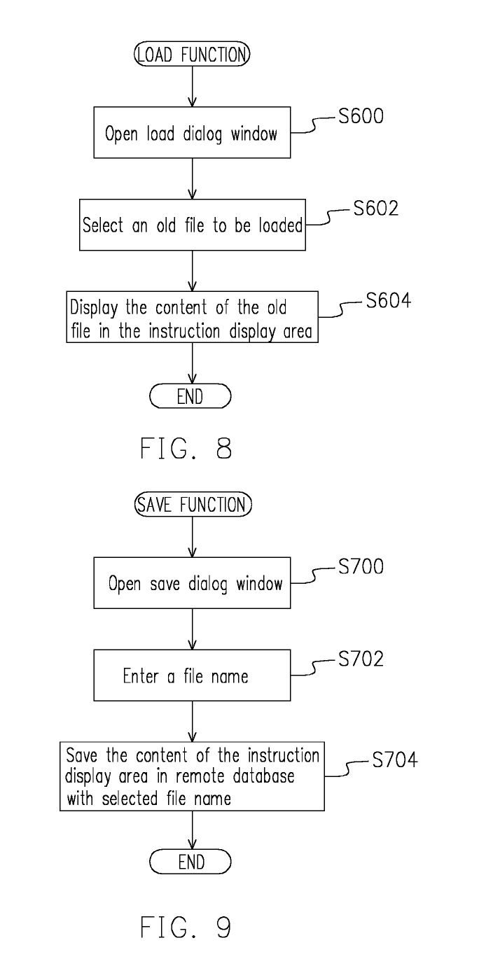

Referring to FIG. 8, it illustrates a schematic flowchart of the load function according to one preferred embodiment of the present invention. The load function comprises the steps that are described as follows. Firstly, opening a load dialog window in step S600. Secondly, selecting an old file to be loaded in step S600. Ultimately, displaying the content of the old file in the instruction display area 54 in step S604.

Referring to FIG. 9, it illustrates a schematic flowchart of the save function according to the present invention. The save function comprises the steps that are described as follows. Firstly, opening a save dialog window in step S700. Secondly, the user inputs a file name in step S702. Next, saving the content of the instruction display area 54 in the remote database with the selected file name in step S704.

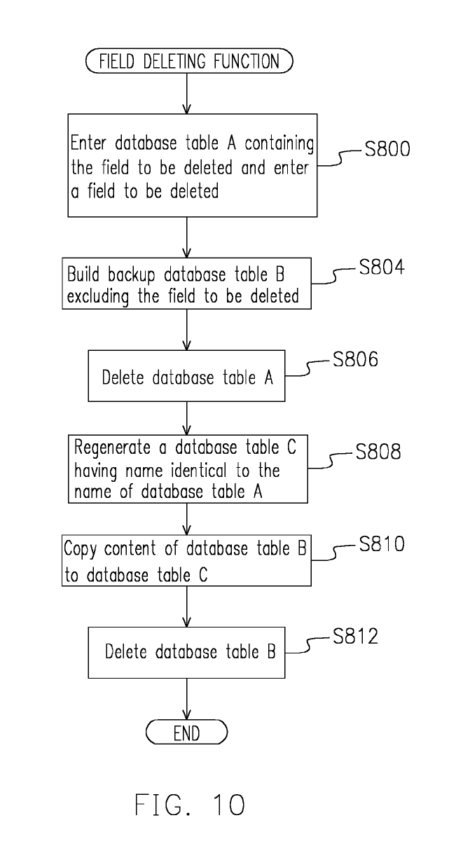

Referring to FIG. 10, it illustrates a schematic flowchart of the field delete function according to one preferred embodiment of the present invention. The field delete function comprises the steps that are described as follows. Firstly, entering a data table name containing the field to be deleted and entering a name of the field to be deleted in the delete dialog window in step S800. Next, building a backup data table B in step S804., where the field to be deleted is excluded.

Further, deleting the data table A in step S806, rebuilding a data table C whose name is identical to the name of the data table A in step S808, and copying the content of the data table B to the data table C in step S810. Ultimately, deleting the data table B in step S812.

Hence the field in the data table is deleted, whereas the conventional SQL Plus does not support such function.

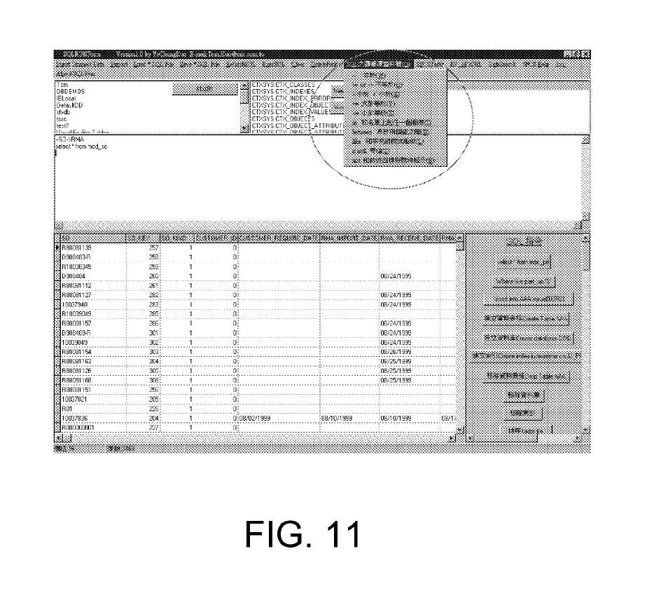

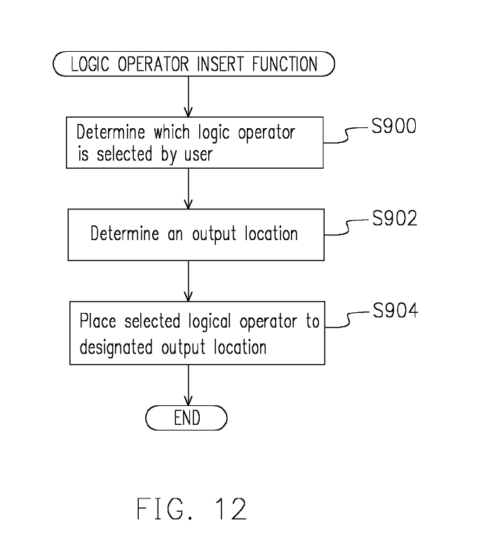

Referring to FIG. 11, it illustrates a schematic view of a window of the logic operator inserting function according to one preferred embodiment of the present invention, wherein a pull-down menu of the insert logic operator is circled. Whereas FIG. 12 illustrates a schematic flowchart of the logic operator inserting function according to one preferred embodiment of the present invention, wherein the logic operator inserting function comprises the steps that are described as follows. Firstly, determining a type of the logic operator selected by the user in step S900, for example, the logic operators such as equal sign (=), non-equal sign (!=), or the inverse sign (not), etc.

Secondly, determining an appropriate output location for the logic operator input by the user corresponding to instruction display area 54 in step S902, for the logic operator is usually placed in a conditional SQL instruction, which is displayed in the instruction display area 54 after macro is expanded. Thus it is to be determine which location the logic operator is to be inserted in the instruction display area 54 so as to place the selected logic operator at the location accordingly in step S904.

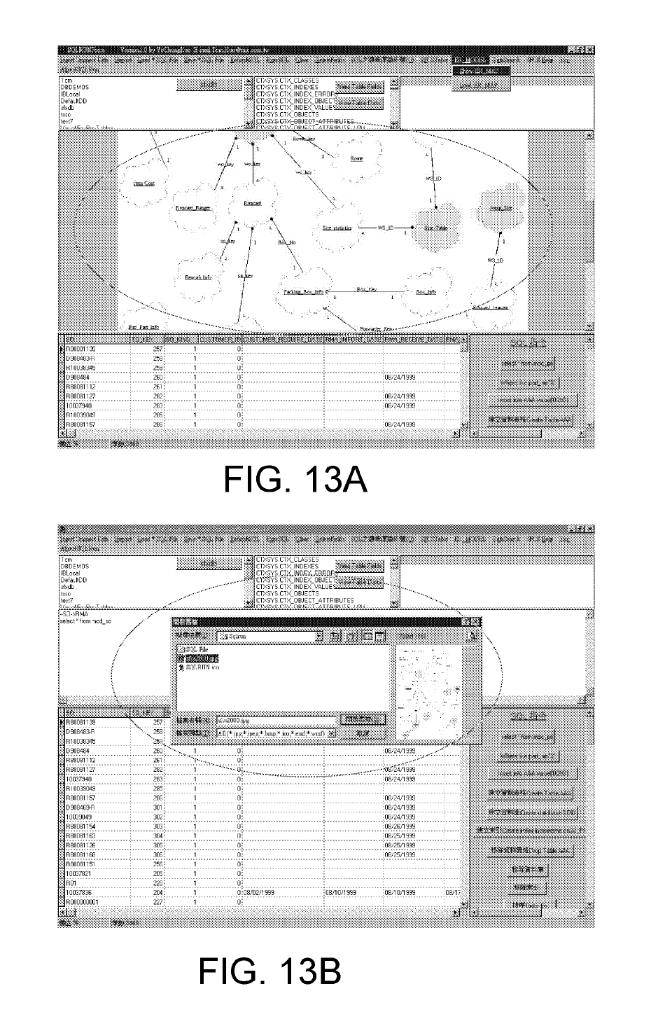

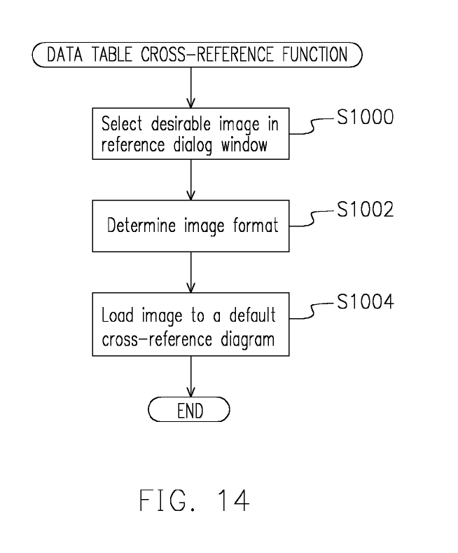

Referring to both FIG. 13A and FIG. 13B, which schematically shows the window of two sub-functions including a display function (Show ER_MAP sub-function) and a load function (Load ER_MAP sub-function) under the cross-reference function of the data table.

The object of cross-reference the data table is based on a fact that one database may comprise a plurality of data tables that correlate to each other. For example, the Box Info data table shown on the bottom of FIG. 13a has one-to-one relationship with the Packing Box Info data table shown on its immediate left; in other words, all data tables may not correlate to one entry. Thus it is necessary to establish a cross-reference function for the data tables.

Similarly, besides the default data table cross-reference diagram (FIG. 13a), a new correlation diagram may be added to the default diagram. For example, the region that is circled in FIG. 13b is portion of a dialog window of inserting new correlation diagram.

FIG. 14 illustrates a schematic flowchart of the data table cross reference function according to one preferred embodiment of the present invention. The data table cross-reference function comprises the steps that are described as follows. Firstly, the user selects a desirable image in the cross-reference dialog window in step S1000. Secondly, determining an image file format of the inserted image, for example, a bitmap format in the step S1002. Ultimately, loading the image to the default cross-reference diagram in step S1004.

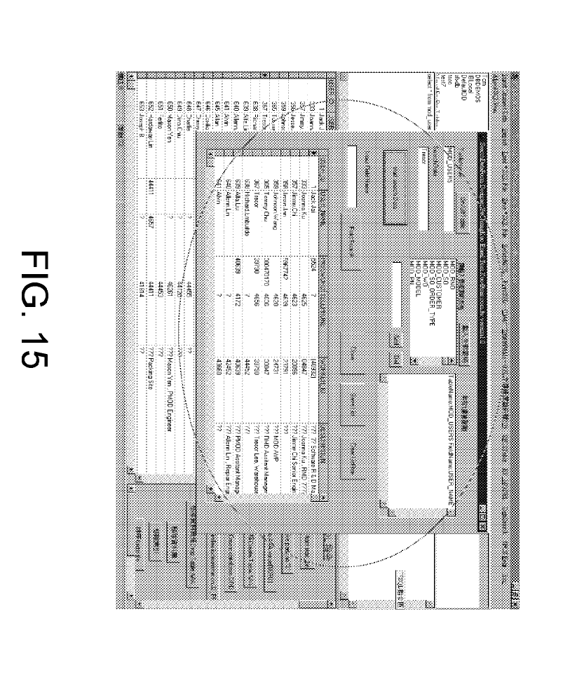

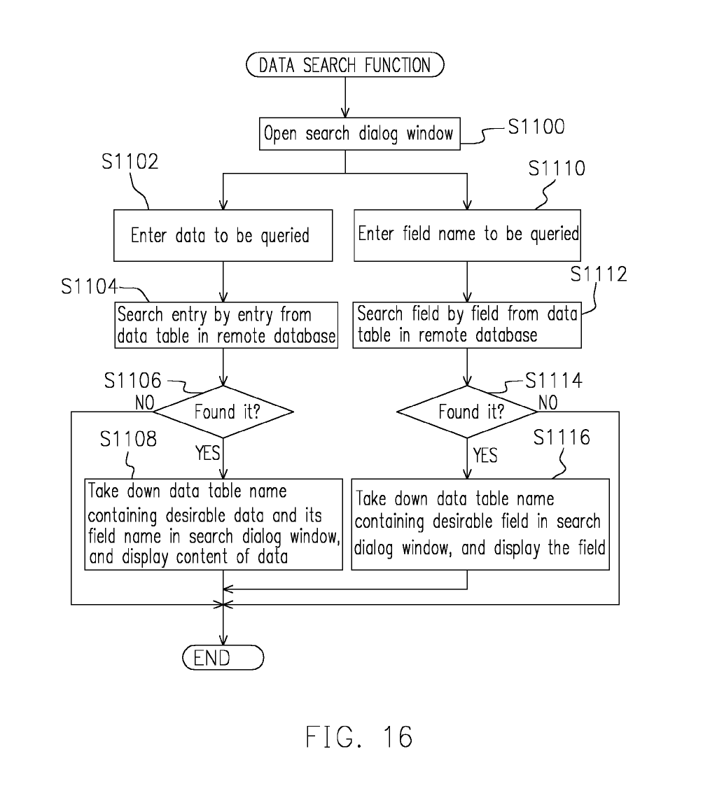

Referring to FIG. 15, wherein the dialog window marked within a large circle is a search dialog window providing the search function. The middle section of the dialog window is for limiting the data tables to be searched, and the selected data table name is shown in the TableName item on the immediate left. The SearchData item on its left is for entering a data to be queried. Once the user presses the start search data button located below the SearchData tab, the query operation starts running, and a query result is shown in the sub-window at the rightmost of the dialog window, which indicates that the data is found in some specific field of some specific data table, and the found entry is shown on a bottom box of the dialog window therein.

In addition, this function can also search for the exact location of the field. Firstly, entering a field name to be searched in the Input Field Name item at the most bottom left of the dialog window. Secondly, a query operation starts running as the Field Data button on the right is pressed. Ultimately, the data table name containing this field and the contents thereof are shown in the rightmost and bottommost boxes of the dialog window.

FIG. 16 illustrates a schematic flowchart of the data search function according to one preferred embodiment of the present invention. The data search function comprises the steps of opening a search dialog window in step S1100, and entering a data name to be queried if performing search function in step S1102.

Further, the function searches for the data entry temptempby entry in the data table in the remote database in step S1104. If the data is found in step S1106, the data table name containing the desirable data and the field name thereof are taken down in the search dialog window, and the content of the desirable data is displayed in the window in step S1108.

If the user opts to search for a field, the function then comprises the steps of entering a field name to be queried in step S1110, searching the field from remote database in step S1112, and taking down the data table name containing the desirable field in the search dialog window as well as displaying therein if the field is found in step S1114.

Conclusively, the merits of the present invention are summarized as follows:1. The present invention provides functions of prompt querying, modifying, editing, testing, and deleting data from remote Oracle database, such that to improve the drawbacks of Oracle database SQL Plus utility where an instruction is given row by row and only one instruction is permitted at a time0.2. The present invention provides the functions of prompt querying, modifying, and editing different data structures of different data tables in the remote database. 3. The present invention provides the function of querying 82 sets of SQL instruction syntax as well as prompt downloading and executing the found SQL syntax in the remote database, such that even a nonprofessional database analyst can possess such professional skills. 4. The present invention provides the function of prompt fetch of total number of the data tables, the fields, and the entries to be queried, so as to improve query efficiency for system developers and software engineers. 5. The present invention provides the function of switching between different remote databases, which directly contributes to the connection of the global remote database. 6. The present invention provides the function of converting the data or the data structure of the data table obtained from query operation into different file formats, or merely to print out on paper, so as to facilitate data integration and paper query analysis for system personnel.7. The present invention provides the function of searching for a specific data in the remote database so as to facilitate system analysis for system personnel.

Although the invention has been described with reference to a particular embodiment thereof, it will be apparent to one of the ordinary skilled in the art that modifications to the described embodiment may be made without departing from the spirit of the invention. Accordingly, the scope of the invention will be defined by the attached claims not by the above detailed description.

1. A method for accessing a remote database using a window program, relating to windowizing SQL syntax for accessing the remote database, wherein a window provided by the window program comprises a command list, a display area, and a SQL instruction area, the remote database comprises a plurality of data tables, and each of the data tables comprises a plurality of fields, each of the fields comprises a plurality of entries, the method for accessing the remote database using the window program comprising:
a user selecting the remote database to be connected with a connect-to-database function in the command list;
determining whether the user is authenticated to access the remote database or not;
permitting the user to select a SQL instruction from the SQL instruction area as the user is authenticated, wherein the SQL instruction is displayed in the display area for further modification, and the SQL instruction comprises a query type SQL instruction and an edit type SQL instruction;
the user executing the SQL instruction that has been modified with an execution function in the command list; and
displaying an execution result obtained from the SQL instruction in the display area.

2. The method for accessing the remote database using the window program of claim 1, wherein a connecting function provided by the connect-to-database function is for determining whether the user is authenticated for accessing the remote database or not, the connecting function comprising:
determining whether a user name and a user password of the user are authenticated foraccessing the remote database or not; and
permitting the user to access the remote database if authenticated.

3. The method for accessing the remote database using the window program of claim 1, wherein the user accesses a plurality of remote database with the window program.

4. The method for accessing the remote database using the window program of claim 1, wherein a plurality of SQL instructions existing in the SQL instruction area comprise a plurality of the SQL instructions in a macro format, and each of the SQL instructions corresponds to a button for expanding the macro.

5. The method for accessing the remote database using the window program of claim 1, wherein the display area comprises a database name display area, a data table display area, a data structure display area, a data display area, and an instruction display area.

6. The method for accessing the remote database using the window program of claim 5, wherein the instruction display area is for displaying the SQL instructions obtained from expanding the macro.

7. The method for accessing the remote database using the window program of claim 6, wherein a clear function in the command list is for clearing a content of the instruction display area.

8. The method for accessing the remote database using the window program of claim 6, wherein a logic operator function in the command list is for inserting a logic operator into the SQL instructions obtained from expanding the macro.

9. The method for accessing the remote database using the window program of claim 5, wherein the database name display area is for displaying the remote database name which serves to be connected.

10. The method for accessing the remote database using the window program of claim 5, wherein the data table display area is for displaying all the data tables in the remote database.

11. The method for accessing the remote database using the window program of claim 5, wherein the data structure display area is for displaying a data structure of the data table.

12. The method for accessing the remote database using the window program of claim 5, wherein the data display area is for displaying the data of each of the fields.

13. The method for accessing the remote database using the window program of claim 1, wherein an export function in the command list is for displaying and saving an execution result in a file format that is different.

14. The method for accessing the remote database using the window program of claim 1, wherein a save function in the command list is for saving the SQL instruction that has been modified into a file.

15. The method for accessing the remote database using the window program of claim 14, wherein the user opts to use the SQL instruction again, the SQL instruction that has been saved and modified is loaded with a load function in the command list.

16. A method for accessing a remote database using a window program, relating to windowizing SQL syntax for accessing the remote database, wherein the remote database comprises a plurality of data tables, each of the data tables comprises a plurality of fields, each of the fields comprises a plurality of entries, the method for accessing the remote database using the window program comprising:
providing a window, wherein the window comprises a command list, a display area, and a SQL instruction area, and the display area further comprises a database name display area, a data table display area, a data structure display area, a data display area, and an instruction display area;
the user being permitted to access the remote database as a user is authenticated; and
the user accessing the entries in the remote database with a plurality of functions in the command list, wherein the functions comprise an execution function, an export function, a load function, a save function, a clear function, a field deleting function, a logic operator inserting function, a data table cross reference function, and a data and field searching function.

17. The method for accessing the remote database using the window program of claim 16, wherein the user being authenticated comprises authenticating a user name and a user password.

18. The method for accessing the remote database using the window program of claim 16, wherein the execution function comprises executing a query type SQL instruction and executing an edit type SQL instruction.

19. The method for accessing the remote database using the window program of claim 18, wherein the SQL instruction area comprises a plurality of the SQL instructions comprising the query type SQL instruction and the edit type SQL instruction, and the SQL instructions are in a macro format in the SQL instruction area.

20. The method for accessing the remote database using the window program of claim 19, wherein executing the query type SQL instruction comprises:
transmitting the query type SQL instruction to the remote database;
the remote database returning a query result to the window program; and
displaying the query result in the data display area.

21. The method for accessing the remote database using the window program of claim 19, wherein executing the edit type SQL instruction comprises:
transmitting the edit type SQL instruction to the remote database; and
the remote database returning a message related to an execution result to the window.

22. The method for accessing the remote database using the window program of claim 16, wherein the export function comprises:
opening an export dialog window, wherein the export dialog window comprises a plurality of file formats;
calling an object of the selected file format as the user selects one of the file formats;
fetching the entries from the remote database; and
displaying the entries in the object of the selected file format.

23. The method for accessing the remote database using the window program of claim 16, wherein the load function comprises:
opening a loading dialog window;
the user selecting an old file to be loaded; and
displaying a content of the old file in the instruction display area.

24. The method for accessing the remote database using the window program of claim 16, wherein the save function comprises:
opening a saving dialog window;
the user entering a file name; and
saving a content of the instruction display area in the remote database with the file name.

25. The method for accessing the remote database using the window program of claim 16, wherein the clear function is for clearing the content of the instruction display area.

26. The method for accessing the remote database using the window program of claim 16, wherein the field deleting function comprises:
the user entering a name of a first data table containing a field and a name of the field in a deleting dialog window for deleting the field;
building a second data table excluding the field;
deleting the first data table;
building a third data table whose name is identical to the first data table;
copying a content of the second data table to the third data table; and
deleting the second data table.

27. The method for accessing the remote database using the window program of claim 16, wherein the logic operator inserting function comprises:
determining a type of the logic operator selected by the user;
determining an output position; and
placing the logic operator selected by the user to the output position.

28. The method for accessing the remote database using the window program of claim 27, wherein the output position is in the instruction display area.

29. The method for accessing the remote database using the window program of claim 16, wherein the data table cross reference function comprises:
the user selecting a desirable image in a reference dialog window;
determining an image format of the image; and
loading the image to a default cross reference diagram.

30. The method for accessing the remote database using the window program of claim 16, wherein the data searching function comprises:
the user entering a data to be queried in a searching dialog window;
searching for the data entry by entry in the data tables in the remote database; and
if the data is found, taking down the data table containing the data and the field in the searching dialog window as well as displaying the data.

31. The method for accessing the remote database using the window program of claim 30, wherein the field searching function comprises:
the user entering a field name to be queried in the searching dialog window;
searching the field one by one in the data tables in the remote database; and
if the field is found, taking down the data table containing the field in the searching dialog window as well as displaying the field.
